(19) United States
(12) Patent Application Publication
(10) Pub. No.: US 2026/0156602 A1
(43) Pub. Date: Jun. 4, 2026

(54) DETECTING MISCLASSIFICATION OF LINE-OF-SIGHT OR NON-LINE-OF-SIGHT INDICATOR

(71) Applicant: Nokia Technologies Oy, Espoo (FI)

(72) Inventors: Anil KIRMAZ, Munich (DE); Taylan SAHIN, Munich (DE); Diomidis MICHALOPOULOS, Munich (DE)

(21) Appl. No.: 19/125,454

(22) PCT Filed: Oct. 11, 2023
(86) PCT No.: PCT/EP2023/078107

§ 371 Date: Apr. 29, 2025

(30) Foreign Application Priority Data
Nov. 3, 2022 (GB) 2216369.5

(51) Int. Cl. H04W 64/00; H04W 24/10

(52) U.S. Cl. CPC H04W 64/00; H04W 24/10

(57) ABSTRACT

Disclosed is a method comprising obtaining a plurality of line-of-sight, LoS, and non-line-of-sight, NLoS, indicators reported from a plurality of user devices; detecting a misclassification associated with at least one LoS indicator or NLoS indicator of the plurality of LoS and NLoS indicators; and transmitting a message indicating the misclassification.

### FIELD

The following example embodiments relate to wireless communication and to positioning.

### BACKGROUND

Positioning technologies may be used to estimate a location of a device. It is desirable to improve the positioning accuracy in order to estimate the device location more accurately.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided an apparatus comprising at least one processor, and at least one memory storing instructions which, when executed by the at least one processor, cause the apparatus at least to: obtain a plurality of line-of-sight, LoS, and non-line-of-sight, NLoS, indicators reported from a plurality of user devices; detect a misclassification associated with at least one LoS indicator or NLoS indicator of the plurality of LoS and NLoS indicators; and transmit a message indicating the misclassification.

According to another aspect, there is provided an apparatus comprising: means for obtaining a plurality of line-of-sight, LoS, and non-line-of-sight, NLoS, indicators reported from a plurality of user devices; means for detecting a misclassification associated with at least one LoS indicator or NLoS indicator of the plurality of LoS and NLoS indicators; and means for transmitting a message indicating the misclassification.

According to another aspect, there is provided a method comprising: obtaining, by an apparatus, a plurality of line-of-sight, LoS, and non-line-of-sight, NLoS, indicators reported from a plurality of user devices; detecting, by the apparatus, a misclassification associated with at least one LoS indicator or NLoS indicator of the plurality of LoS and NLoS indicators; and transmitting, by the apparatus, a message indicating the misclassification.

According to another aspect, there is provided a computer program comprising instructions which, when executed by an apparatus, cause the apparatus to perform at least the following: obtaining a plurality of line-of-sight, LoS, and non-line-of-sight, NLoS, indicators reported from a plurality of user devices; detecting a misclassification associated with at least one LoS indicator or NLoS indicator of the plurality of LoS and NLoS indicators; and transmitting a message indicating the misclassification.

According to another aspect, there is provided a computer readable medium comprising program instructions which, when executed by an apparatus, cause the apparatus to perform at least the following: obtaining a plurality of line-of-sight, LoS, and non-line-of-sight, NLoS, indicators reported from a plurality of user devices; detecting a misclassification associated with at least one LoS indicator or NLoS indicator of the plurality of LoS and NLoS indicators; and transmitting a message indicating the misclassification.

According to another aspect, there is provided a non-transitory computer readable medium comprising program instructions which, when executed by an apparatus, cause the apparatus to perform at least the following: obtaining a plurality of line-of-sight, LoS, and non-line-of-sight, NLoS, indicators reported from a plurality of user devices; detecting a misclassification associated with at least one LoS indicator or NLoS indicator of the plurality of LoS and NLoS indicators; and transmitting a message indicating the misclassification.

According to another aspect, there is provided an apparatus comprising at least one processor, and at least one memory storing instructions which, when executed by the at least one processor, cause the apparatus at least to: receive a message indicating a misclassification associated with at least one line-of-sight, LoS, indicator or non-line-of-sight, NLoS, indicator reported by the apparatus; and

perform, based on the message, one or more actions for increasing positioning estimate accuracy.

According to another aspect, there is provided an apparatus comprising: means for receiving a message indicating a misclassification associated with at least one line-of-sight, LoS, indicator or non-line-of-sight, NLoS, indicator reported by the apparatus; and means for performing, based on the message, one or more actions for increasing positioning estimate accuracy.

According to another aspect, there is provided a method comprising: receiving, by an apparatus, a message indicating a misclassification associated with at least one line-of-sight, LoS, indicator or non-line-of-sight, NLoS, indicator reported by the apparatus; and performing, by the apparatus, based on the message, one or more actions for increasing positioning estimate accuracy.

According to another aspect, there is provided a computer program comprising instructions which, when executed by an apparatus, cause the apparatus to perform at least the following: receiving a message indicating a misclassification associated with at least one line-of-sight, LoS, indicator or non-line-of-sight, NLoS, indicator reported by the apparatus; and performing, based on the message, one or more actions for increasing positioning estimate accuracy.

According to another aspect, there is provided a computer readable medium comprising program instructions which, when executed by an apparatus, cause the apparatus to perform at least the following: receiving a message indicating a misclassification associated with at least one line-of-sight, LoS, indicator or non-line-of-sight, NLoS, indicator reported by the apparatus; and performing, based on the message, one or more actions for increasing positioning estimate accuracy.

According to another aspect, there is provided a non-transitory computer readable medium comprising program instructions which, when executed by an apparatus, cause the apparatus to perform at least the following: receiving a message indicating a misclassification associated with at least one line-of-sight, LoS, indicator or non-line-of-sight, NLoS, indicator reported by the apparatus; and performing, based on the message, one or more actions for increasing positioning estimate accuracy.

### LIST OF DRAWINGS

In the following, various example embodiments will be described in greater detail with reference to the accompanying drawings, in which

FIG. 1 illustrates an example of a cellular communication network;

FIG. 2 illustrates an example of positioning error;

FIG. 3A illustrates an example of the distribution of root mean square delay spread for line-of-sight vs non-line-of-sight measurements with different available bandwidths in a first scenario;

FIG. 3B illustrates an example of the distribution of root mean square delay spread for line-of-sight vs non-line-of-sight measurements with different available bandwidths in a second scenario;

FIG. 4 illustrates a signaling diagram;

FIG. 5 illustrates a signaling diagram;

FIG. 6 illustrates a signaling diagram;

FIG. 7 illustrates a flow chart;

FIG. 8 illustrates a flow chart;

FIG. 9 illustrates an example scenario;

FIG. 10 illustrates an example scenario;

FIG. 11 illustrates an example of an apparatus; and

FIG. 12 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

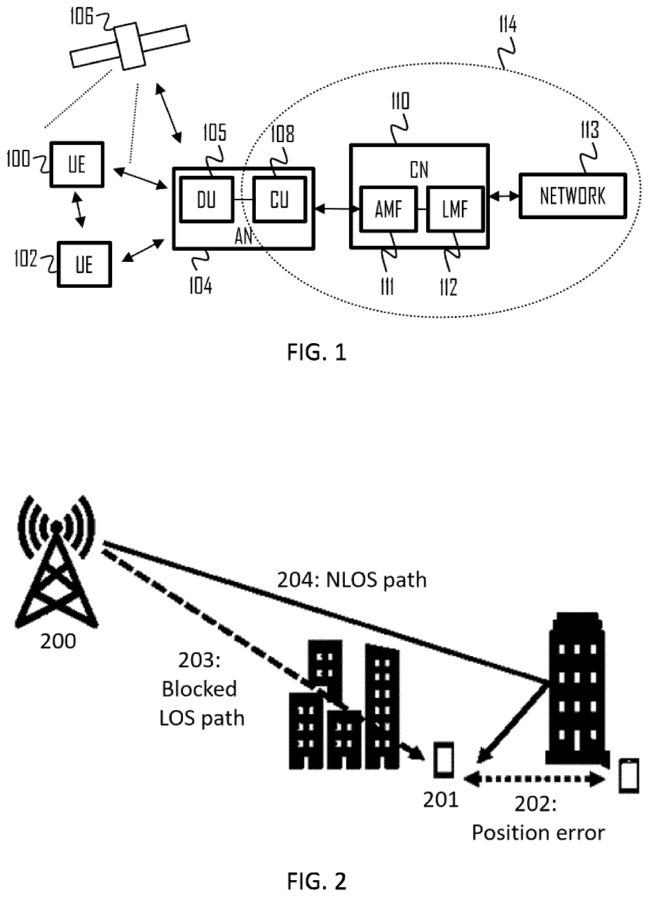

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

With respect to positioning, the service-based architecture (core network) may comprise an AMF 111 and a location management function (LMF) 112. The AMF may provide location information for call processing, policy, and charging to other network functions in the core network and to other entities requesting for positioning of terminal devices. The AMF may receive and manage location requests from several sources: mobile-originated location requests (MO-LR) from the user devices and mobile-terminated location requests (MT-LR) from other functions of the core network or from other network elements. The AMF may select the LMF for a given request and use its positioning service to trigger a positioning session. The LMF may then carry out the positioning upon receiving such a request from the AMF. The LMF may manage the resources and timing of positioning activities. The LMF may use a Namf_Communication service on an NL1 interface to request positioning of a user device from one or more access nodes, or the LMF may communicate with the user device over N1 for UE-based or UE-assisted positioning. The positioning may include estimation of a location and, additionally, the LMF may also estimate movement or accuracy of the location information when requested. Connection-wise, the AMF may be between the access node and the LMF and, thus, closer to the access nodes than the LMF.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHZ-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning techniques may be used to estimate a location (e.g., geographic location) of a user device. Herein the user device to be positioned is referred to as a target UE or target user device. For example, the positioning techniques used in NR may be based on at least one of the following: time difference of arrival (TDoA), time of arrival (TOA), time of departure (TOD), round trip time (RTT), angle of departure (AoD), angle of arrival (AoA), and/or carrier phase.

In UL/DL positioning, multiple transmission and reception points (TRPs) in known locations may transmit and/or receive one or more positioning reference signals (PRS) to/from the target UE. In the uplink, a sounding reference signal (SRS) may be used as a positioning reference signal. For example, multilateration techniques may then be used to localize (i.e., position) the target UE with respect to the TRPs. One TRP out of these TRPs may be used as a positioning anchor, and the differences in TDoA may be computed with respect to this positioning anchor. The positioning anchor may also be referred to as an anchor, anchor node, multilateration anchor, or reference point herein.

Sidelink (SL) positioning refers to the positioning approach, where the target UE utilizes the sidelink (i.e., the direct device-to-device link) to position itself, either in an absolute manner (in case of absolute positioning) or in a relative manner (in case of relative positioning). For UE-assisted positioning (in SL positioning and UL/DL positioning), the target UE may utilize the sidelink to obtain positioning measurements and report the measurements to a network entity such as a location management function (LMF). Sidelink positioning may also be used to obtain ranging information.

Ranging means determination of the distance between two UEs and/or the direction of one UE from the other one via direct device connection.

Absolute positioning means estimating the position of the target UE in two-dimensional or three-dimensional geographic coordinates (e.g., latitude, longitude, and/or elevation) within a coordinate system.

Relative positioning means estimating the position of the target UE relative to other network nodes or relative to other UEs.

SL positioning may be based on the transmission of a sidelink positioning reference signal (SL PRS) by multiple anchor UEs (anchor user devices), wherein the SL PRS is received and measured by a target UE to enable localization of the target UE within precise latency and accuracy requirements of the corresponding SL positioning session. Alternatively, or additionally, the target UE may transmit SL PRS to be received and measured by the anchor UEs. SL PRS refers to a reference signal transmitted over SL for positioning purposes.

An anchor UE may be defined as a UE supporting positioning of the target UE, for example by transmitting and/or receiving reference signals (e.g., SL PRS) for positioning over the SL interface. This may be similar to UL/DL-based positioning, where gNBs may serve as anchors transmitting and/or receiving reference signals to/from target UEs for positioning.

FIG. 2 illustrates an example of positioning error 202 of a target UE 201 due to non-line-of-sight propagation. Most time-based and angle-based positioning techniques anticipate a direct path 203, i.e., line-of-sight (LoS) propagation between the transmitter (e.g., base station 200) and receiver (e.g., UE 201). If the direct path 203 is blocked and the signal arrives at the receiver from an indirect path 204, i.e., there is a high probability to have a non-line-of-sight (NLoS) propagation, the positioning accuracy may be degraded due to inaccurate ranging, or an incorrect estimation of geometry for time-based and angle-based techniques, respectively.

Therefore, classifying the channel measurements as LoS/NLoS may enhance the positioning performance. In other words, LoS/NLoS classification may be used to differentiate LoS channels from NLoS channels. Such classification outcome can be used in many ways during the position estimation, for example by disregarding NLoS measurements and prioritizing LoS measurements for selecting clean distance information. Herein the term “channel” may refer to at least one radio resource for transmitting and/or receiving data, signal, information, message, etc.

The LoS/NLoS classification means that the UE and/or the network node classifies channel measurements or one or more received signals (e.g., one or more received waveforms) as line-of-sight or non-line-of-sight based on a received waveform, an estimated channel response, or an extracted feature set. For example, the UE may classify any UE measurements that are used for positioning purposes, wherein these measurements are shaped by the transmitted waveform and the channel. The LoS/NLoS classification may be done by the UE per link with the gNB or TRP, or vice versa.

The feature set may comprise one or more radio channel features. For example, the feature set may comprise at least one of the following features: root mean square (RMS) delay spread, average or total energy of one or more received channel responses or waveforms, kurtosis, mean excess delay, maximum amplitude of the one or more received channel responses or waveforms, rise time, skewness, Rician K-factor (or maximum power/amplitude divided by average power/amplitude), and/or standard deviation or variance of the one or more received channel responses or waveforms.

Based on the LoS/NLoS classification, LoS/NLoS indicators may be reported to the LMF for DL and DL+UL positioning measurements taken at the UE for UE-assisted positioning, or UL and DL+UL measurements taken at the TRP for NG-RAN assisted positioning.

The LoS/NLoS indicator may be called a LoS indicator, if the LoS/NLoS indicator indicates LoS likelihood, for example if the LoS/NLoS indicator comprises a value of 1 (in case of hard binary classification) or >0.5 (in case of soft/probabilistic classification).

The LoS/NLoS indicator may be called an NLoS indicator, if the LoS/NLoS indicator indicates NLoS likelihood, for example if the LoS/NLoS indicator comprises a value of 0 (in case of hard binary classification) or <0.5 (in case of soft/probabilistic classification).

It should be noted that a value of 0.5 (in case of soft/probabilistic classification) may mean that the estimated probability for the current input to be in a given class is equal, i.e., the adopted classifier cannot classify the current input.

Artificial intelligence (AI) or machine learning (ML) based LoS/NLoS identification may be used to provide positioning accuracy enhancement. In direct AI/ML positioning, the output of the AI/ML model inference is the UE location. For this positioning technique, measurements conducted by the UE at various locations within the network may be utilized to build a comprehensive dataset that may be used to train a machine learning model that can predict the UE location.

In AI/ML-assisted positioning, the output of the AI/ML model inference is a new measurement and/or an enhancement of an existing measurement, such as LoS/NLoS identification, timing and/or angle of measurement, or likelihood of measurement. These new measurements and/or enhancement of existing measurement may then be used to determine the UE location, which may achieve higher accuracy than legacy approaches.

The complex nature of a radio environment leads to difficulty in modelling radio propagation conditions accurately. Therefore, data-driven techniques and machine learning may be beneficial in the LoS/NLoS classification. The LoS/NLoS classification algorithms may make use of the fact that LoS and NLoS channel measurements or channel impulse responses (CIRs) look different from each other. Such differences may be numerically expressed through the values of relevant features extracted from CIRs. For example, NLoS CIRs may be associated with a higher delay spread, a less peaky CIR shape, a lower strongest-to-mean power ratio, a higher rise time, etc., compared to LoS CIRs.

The radio environment may vary among different scenarios depending on the size, distribution, and material of the objects/blockers in the environment, leading to differences in penetration, reflection, and diffraction of radio signals from such objects. Similarly, the amount of available bandwidth (BW), affects the shape of CIRs via determining the time resolution of CIRs, further affecting the features extracted from CIRs. As a result, the distinguishing ability of features exhibit differences across different available bandwidths and different scenarios.

The time resolution of CIRs is one of the major factors affecting LoS/NLoS classification accuracy. CIRs with higher time resolution describe the propagation channel more accurately and help differentiating different signal paths, thereby allowing classification with higher accuracy. The time resolution of CIRs may be defined by the amount of available bandwidth. The lower the bandwidth, the less time resolution/details the CIRs have. As a result, the LoS/NLoS classification accuracy is negatively affected by lowering bandwidth.

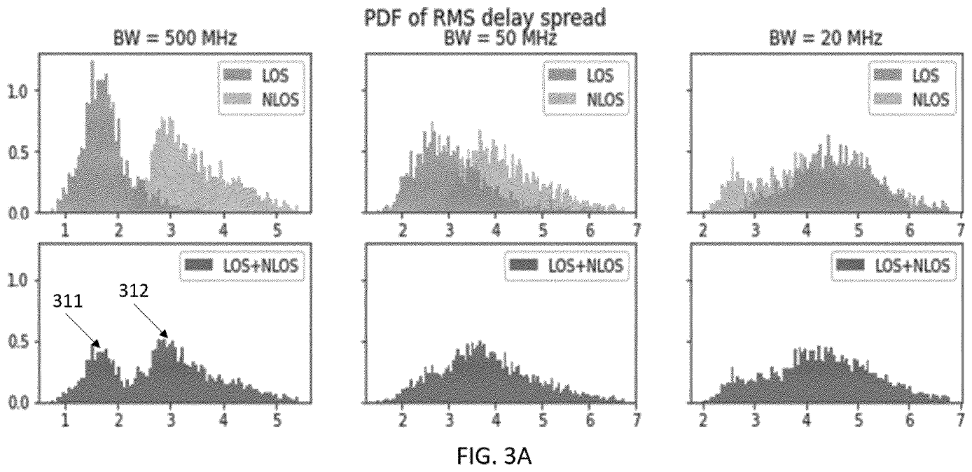

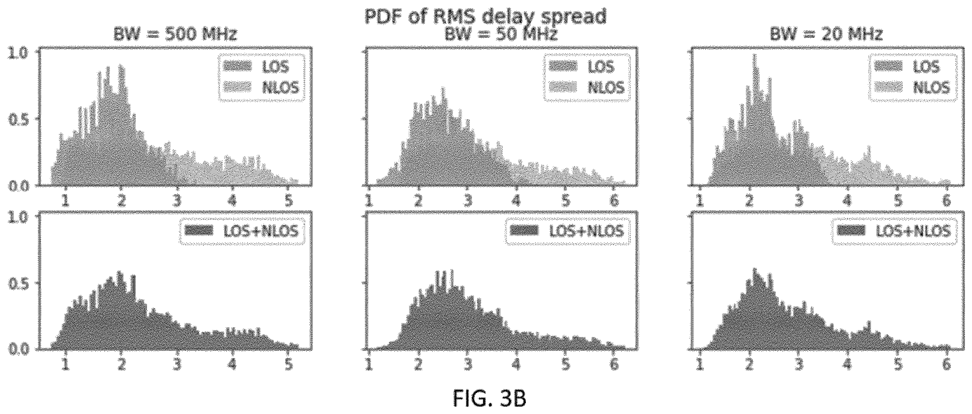

FIG. 3A illustrates an example of the distribution (i.e., probability density function, PDF) of RMS delay spread for LoS vs NLoS measurements with different available bandwidths in a first scenario.

FIG. 3B illustrates an example of the distribution (i.e., PDF) of RMS delay spread for LoS vs NLoS measurements with different available bandwidths in a second scenario.

In the first scenario of FIG. 3A, the RMS delay spread is a distinguishing channel feature for LoS/NLoS classification, when 500 MHz of BW is available. However, its distinguishing ability is degraded for 50 MHz or lower of BW in the first scenario of FIG. 3A. Note the unlabeled measurements (LoS+NLoS) shown in FIG. 3A, where there are two clear peaks 311, 312 belonging to LoS and NLoS measurements for 500 MHz of BW, while there are no distinguishable peaks for 50 MHz or 20 MHz of BW. This results from the fact that the features extracted from CIRs represent the channel more inaccurately, when the CIRs have lower time resolution.

For the second scenario of FIG. 3B, the RMS delay spread is not a good classifier even for 500 MHz of available BW (i.e., in FIG. 3B, there are no distinguishable peaks even for 500 MHz of BW).

The classifier complexity is another factor that may affect the LoS/NLoS classification accuracy. For example, a well-trained deep neural network classifier may result in a better classification performance compared to a simple thresholding scheme. On the other hand, such improved performance may come at the expense of a higher computational load.

However, not all UEs in a cellular network necessarily have the high bandwidth and high computational capability and power needed for LoS/NLoS classification. Further, even if they are capable, selection of non-optimal techniques, such as using unsuitable feature extraction for the classification, may easily degrade the accuracy of their LoS/NLoS estimation. Such incorrect classification outcome (i.e., misclassification) may in turn lead to inaccurate position estimations. Thus, there is a need for a mechanism to enable verification and/or warning for UEs about their possibly incorrect indication of LoS/NLoS classification of the channels.

Some example embodiments provide a mechanism to verify and improve LoS/NLoS classification accuracy and integrity of UEs by exploiting the information reported by other UEs in the vicinity. Thus, inconsistencies among the reported LoS/NLoS indicators and/or related measurements may be detected, for example based on capability information of the UEs (e.g., by comparing LoS/NLoS indicators of low-BW and high-BW UEs in vicinity of each other).

Some example embodiments are described below using principles and terminology of 5G technology without limiting the example embodiments to 5G communication systems, however.

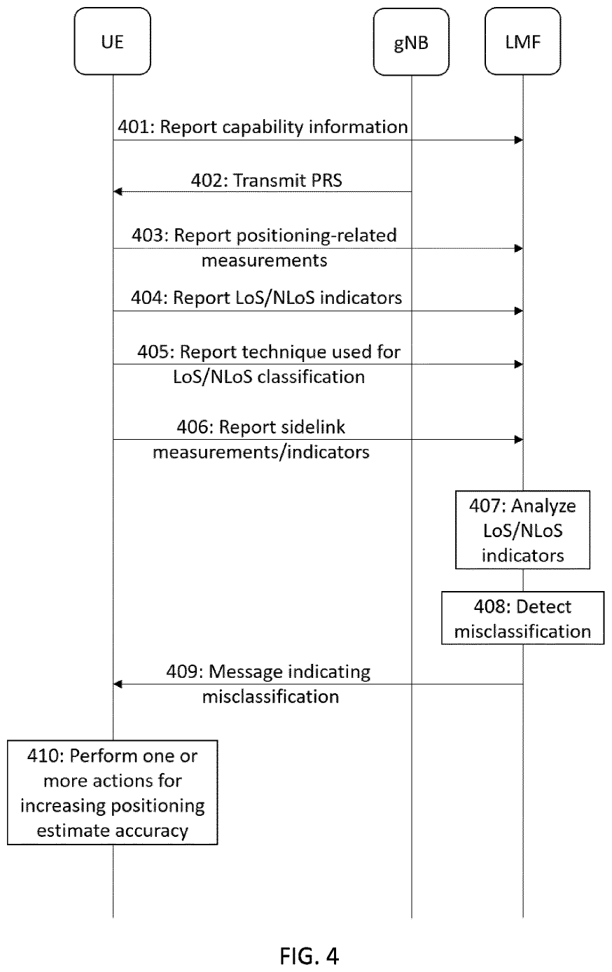

FIG. 4 illustrates a signaling diagram according to an example embodiment.

Referring to FIG. 4, in block 401, a plurality of user devices report capability information to a network node and/or a core network entity (such as an LMF). For example, the user devices may report the capability information to the LMF via the LTE positioning protocol (LPP). Alternatively, the user devices may report the capability information to a network node (e.g., gNB or TRP) of a radio access network, and the network node may then forward the capability information to the LMF via NR positioning protocol A (NRPPa). The LMF may correspond to the LMF 112 of FIG. 1. The network node may correspond to the access node 104 or 106 of FIG. 1. The plurality of user devices may correspond to the UEs 100, 102 of FIG. 1.

For example, the capability information may indicate at least one of the following: a computational capability, one or more bandwidth capabilities, and/or one or more configured bandwidth parts of a given user device. The bandwidth capability may refer to an available or supported bandwidth at the user device for positioning. A given user device may be configured with one or more configured bandwidth parts (BWP) or carriers, each with its own channel bandwidth.

Herein it may be assumed that user devices with different positioning-related capabilities (e.g., supported BW, computational power, etc.) reside together in a certain area.

In block 402, the network node (e.g., gNB or TRP) transmits one or more downlink positioning reference signals, which are measured by the plurality of user devices performing DL positioning. The plurality of user devices may also transmit an uplink positioning reference signal such as UL SRS to the network node.

In block 403, the plurality of user devices report positioning-related measurements to the LMF. The positioning-related measurements may be associated with the DL PRS and/or the UL SRS. The positioning-related measurements may comprise, for example, at least one of the following: reference signal time difference (RSTD), time difference between reception of DL PRS and transmission of UL SRS, reference signal received power (RSRP), time of arrival (TOA), time of departure (TOD), angle of departure (AoD), and/or angle of arrival (AoA) measurements.

For example, the user devices may report the measurements to the LMF via LPP. Alternatively, the user devices may report the measurements to the network node (e.g., gNB or TRP), and the network node may then forward the measurements to the LMF via NRPPa.

In block 404, a given user device of the plurality of user devices reports at least one LoS/NLoS indicator (for example, at least one LoS indicator and/or at least one NLoS indicator) to the LMF based on the one or more positioning reference signals received from the network node. Thus, the LMF obtains a plurality of LoS and NLoS indicators reported from the plurality of user devices. The plurality of LoS and NLoS indicators may comprise one or more LoS indicators and one or more NLoS indicators.

For example, the user devices may report the LoS/NLoS indicators to the LMF via LPP. Alternatively, the user devices may report the LoS/NLoS indicators to the network node (e.g., gNB or TRP), and the network node may then forward the LoS/NLoS indicators to the LMF via NRPPa.

A given LoS/NLoS indicator may be a hard binary indicator, e.g., 0 or 1, or it may be a soft indicator between 0 and 1 representing a given user device's evaluation of the LoS probability. In other words, the LoS/NLoS indicator may be the LoS indicator or the NLoS indicator according to the probability. In this case, the LoS indicator may indicate a probability of LoS or a binary LoS classification, and the NLoS indicator may indicate a probability of NLoS or a binary NLoS classification.

In block 405, the plurality of user devices may report, to the LMF, the technique used by the user devices for LoS/NLoS classification. Some examples of the technique may include (but are not limited to) thresholding, clustering, use of probabilistic models, or use of machine learning techniques based on certain channel features, received signal characteristics, channel impulse response and/or estimated positioning-related parameters such as ToA and/or AoA.

For example, the user devices may report the technique to the LMF via LPP. Alternatively, the user devices may report the technique to the network node (e.g., gNB or TRP), and the network node may then forward the information to the LMF via NRPPa.

In block 406, the plurality of user devices may report, to the LMF, sidelink measurements and/or SL LoS and NLoS indicators associated with a sidelink channel. In other words, at least a part of the plurality of LoS and NLoS indicators may be related to a sidelink channel. For example, the plurality of user devices may report SL conditions and/or positioning-related measurements, such as SL LoS/NLoS classification, relative position, range, angle, etc., between each other.

For example, the user devices may report the sidelink measurements and/or SL LoS and NLoS indicators to the LMF via LPP. Alternatively, the user devices may report the sidelink measurements and/or SL LoS and NLoS indicators to the network node (e.g., gNB or TRP), and the network node may then forward the information to the LMF via NRPPa.

The reports of blocks 403-406 may be transmitted in separate messages, or they may be transmitted in a single message.

In block 407, the LMF analyzes the plurality of LoS and NLoS indicators reported from the plurality of user devices to check for any inconsistencies among the LoS/NLoS indicators. The LMF may further analyze the related measurements, capability information (BW, computational power, etc.), and/or spatial distribution of the user devices (e.g., based on rough/coarse location information).

Alternatively, or additionally, the LMF may analyze at least one of the following to check for any inconsistencies among the LoS/NLoS indicators: one or more LoS/NLoS indicators for the sidelink channel between user devices, the user devices' relative position, range, or angle between them (over the sidelink), number of high-BW/complexity or low-BW/complexity user devices, and/or degree of probability of soft LoS/NLoS indicators (e.g., LoS with 0.9 probability vs LoS with 0.6 probability) reported by high-BW/complexity or low-BW/complexity user devices.

In block 408, the LMF detects, based on analyzing the plurality of LoS and NLoS indicators, a misclassification (or at least a possible/potential misclassification) associated with at least one LoS indicator or NLoS indicator of the plurality of LoS and NLoS indicators.

For example, the misclassification may be detected based at least partly on at least one of: the capability information of the plurality of user devices, the spatial distribution of the plurality of user devices, or the measurement information associated with the plurality of LoS and NLoS indicators.

Alternatively, or additionally, the misclassification may be detected based at least partly on at least one of: the relative position of the plurality of user devices, the range of the plurality of user devices, the angle between the plurality of user devices, or the angle between the plurality of user devices and the network node (e.g., gNB or TRP). The angle information may be part of the LMF's knowledge on the spatial distribution of the user devices, and it may comprise measurements between a given user device and the network node, and/or between a given user device and other user devices (in case of sidelink).

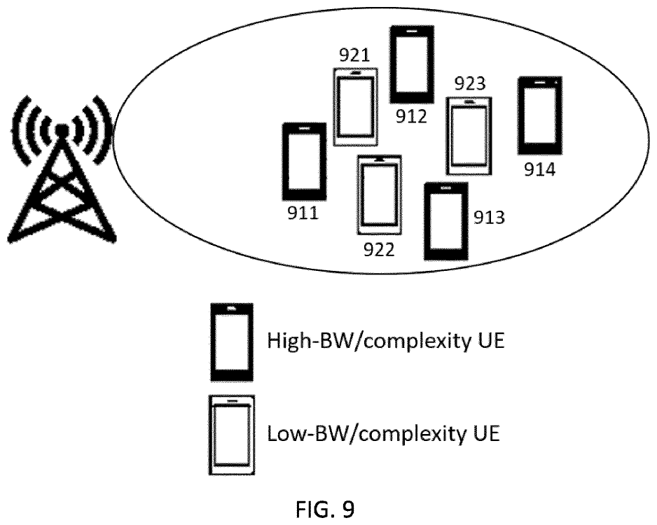

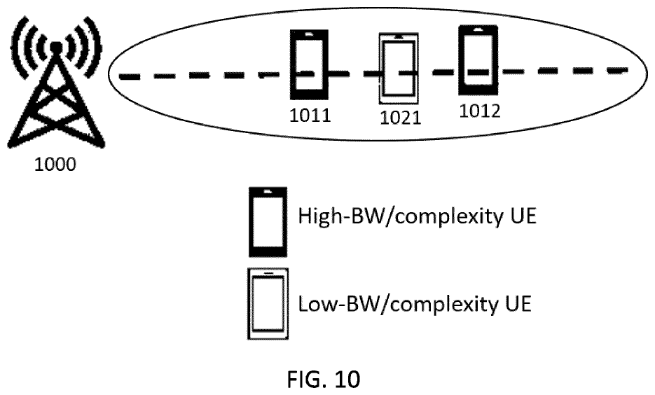

Alternatively, or additionally, the misclassification may be detected based at least partly on a number of first user devices and a number of second user devices among the plurality of user devices, wherein the second user devices are associated with a lower bandwidth or complexity than the first user devices. Herein the first user devices may refer to high-BW and/or high-complexity user devices, and the second user devices may refer to low-BW and/or low-complexity user devices (see the example scenarios of FIG. 9 and FIG. 10).

For example, if a low-BW user device reports a LoS indicator as opposed to a NLoS indicator reported by one or more high-BW user devices nearby (e.g., based on a rough location estimate available at the LMF), then the LoS indicator reported by the low-BW user device may be detected as misclassified.

As another example, if a low-BW user device reports a LoS indicator as opposed to a NLoS indicator reported by one or more high-BW user devices residing co-linearly with respect to a gNB or TRP (e.g., based on AoD information available at the LMF), then the LoS indicator reported by the low-BW user device may be detected as misclassified.

As another example, if a low-BW user device reports a LoS indicator as opposed to a NLoS indicator reported by one or more high-BW user devices nearby, and the one or more high-BW user devices report a relatively short range to the low-BW user device over sidelink, then the LoS indicator reported by the low-BW user device may be detected as misclassified.

As another example, if a user device using a certain feature (denoted as feature X) for channel classification reported a LoS indicator, and another user device nearby (e.g., based on rough location estimate available at the LMF) using another feature (denoted as feature Y) reported an NLoS indicator, and the LMF previously determined that feature Y provides better LoS/NLoS classification accuracy in the given environment compared to feature X, then the LoS indicator reported by the user device using feature X may be detected as misclassified.

In another example, if fewer high-BW user devices report a Los indicator with high confidence (probability), and more low-BW user devices report an NLoS indicator with low confidence, and the high-BW user devices are spatially located in a way that they would experience very similar channels with the low-BW user devices, then the NLoS indicator reported by the low-BW user devices may be detected as misclassified.

In another example, if fewer high-BW user devices report a Los indicator with low confidence (probability), and more low-BW user devices report an NLoS indicator with high confidence, and the high-BW user devices are spatially located in a way that they have different propagation conditions than the low-BW user devices, then the NLoS indicator reported by the low-BW user devices may not be detected as misclassified.

In block 409, in case of detecting a misclassification, the LMF generates and transmits a warning message indicating the misclassification associated with the at least one LoS indicator or NLoS indicator of the plurality LoS and NLoS indicators. The LMF may transmit the warning message to the least one user device (e.g., low-BW and/or low-complexity UE), for which the misclassification was detected. Alternatively, the LMF may transmit the warning message to all user devices of the plurality of user devices.

The warning message may comprise an identifier of one or more user devices of the plurality of user devices, wherein the misclassification is based on a LoS or NLoS indicator reported from the one or more user devices. In other words, the warning message may comprise the IDs of the other user devices involved in the warning determination process. For example, the LMF may indicate, to a low-BW user device, that the high-BW user devices with IDs {Z} and {V} have reported a different LoS/NLoS indicator than the low-BW user device.

Alternatively, or additionally, the warning message may comprise information indicating a technique applied by one or more other user devices for determining a LoS or NLoS indicator reported from the one or more other user devices. This way, the LMF may help weaker user devices to find a better technique. The technique indicated by the LMF may correspond to the technique reported by the one or more other user devices in block 405.

Alternatively, or additionally, the warning message may comprise an indication for triggering uplink measurements to exploit the reciprocity property of the channel to determine the LoS/NLoS condition. The triggering of uplink measurements means that the at least one user device is triggered to transmit an uplink positioning reference signal such as UL SRS to the network node, and the network node measures the UL SRS transmitted by the at least one user device and reports the measurements to the LMF.

Alternatively, or additionally, the warning message may comprise an indication indicating a reliability of the misclassification. For example, the reliability may be indicated as a probability, e.g., a value between 0 and 1, or as a binary value indicating high or low probability.

In block 410, the at least one user device (for which the misclassification was detected) performs, based on the received warning message, one or more actions for increasing positioning estimate accuracy.

For example, the one or more actions may comprise transmitting, to one or more user devices, a request to confirm a LoS indicator or a NLoS indicator reported from the one or more user devices, wherein the misclassification is based on the LoS indicator or NLoS indicator reported from the one or more user devices. The at least one user device may identify the one or more user devices based on the identifier(s) that may be comprised in the warning message. In other words, the user device receiving the warning message may request (e.g., via sidelink) one or more nearby user devices (whose LoS/NLoS indicator report resulted in the inconsistency leading to the warning) to confirm their report. For example, the user device receiving the warning message may request another user device (e.g., high-BW or high-capability UE) in the area to verify the validity of the warning message based on the other user device's location estimation and/or historical data regarding LoS/NLoS information at the given location.

Alternatively, or additionally, the one or more actions may comprise transmitting, to one or more user devices, an indication indicating the misclassification, wherein the misclassification is based on a LoS indicator or a NLoS indicator reported from the one or more user devices. The at least one user device may identify the one or more user devices based on the identifier(s) that may be comprised in the warning message. In other words, the user device receiving the warning message may indicate (e.g., via sidelink) to one or more nearby user devices (whose LoS/NLoS indicator report resulted in the inconsistency) the outcome of such inconsistency.

Alternatively, or additionally, the one or more actions may comprise verifying a validity of the misclassification based on at least one of: a location estimation of the at least one user device, or historical information associated with one or more LoS or NLoS indicators at a location associated with the misclassification. In other words, the user device (for which the misclassification was detected) may verify the validity of the warning message based on its own location estimation and/or its own historical data regarding LoS/NLoS information at the given location.

Alternatively, or additionally, the one or more actions may comprise evaluating a classification accuracy associated with the at least one LoS or NLoS indicator reported by the at least one user device. In other words, the user device may re-investigate its LoS/NLoS classification accuracy.

Alternatively, or additionally, the one or more actions may comprise changing the classification outcome based on the warning, for example changing a LoS indicator to an NLoS indicator, or changing an NLoS indicator to a LoS indicator. The changing may be based on the reliability of the misclassification, which may be indicated in the warning message.

Alternatively, or additionally, the one or more actions may comprise adjusting a classifier used to classify the at least one LoS or NLoS indicator reported by the at least one user device (for which the misclassification was detected). For example, the adjusting may mean using a different feature in the classifier. As another example, if a low-BW/complexity user device receives multiple warnings, it may change its classifier or request assistance from the LMF for such classifier change.

Alternatively, or additionally, the one or more actions may comprise disregarding a positioning reference signal associated with the misclassification. In other words, in this case, the at least one user device does not use or report the PRS associated with the misclassification for estimating its position. In this case, the at least one user device may do positioning estimation based on PRSs associated with LoS/NLoS indicators that did not result in a warning message.

Alternatively, or additionally, the one or more actions may comprise switching to a positioning technique that does not require the at least one LoS or NLoS indicator. In other words, the at least one user device may switch to another positioning scheme, for example fingerprinting-based positioning, which does not anticipate/require LoS/NLoS classification.

Alternatively, or additionally, the one or more actions may comprise disregarding (ignoring) the misclassification, if the at least one user device trusts its LoS/NLoS classification.

Alternatively, or additionally, in case the at least one user device received information indicating a technique applied by one or more other user devices for determining a LoS or NLoS indicator reported from the one or more other user devices, then the at least one user device may apply the indicated technique for its own LoS/NLoS classification. For example, this information may be received from the LMF in the warning message. Alternatively, the one or more other user devices may indicate to the least one user device (e.g., low-BW UE) directly via sidelink the technique they applied for LoS/NLoS classification.

In block 405, the indication of the method/technique used for LoS/NLoS classification may be transmitted, for example, in the LPP information element (IE) LoS-NLoS-Indicator by including a field called “method” in the message. The LoS-NLoS-Indicator information element provides information on the likelihood of a LoS propagation path from the source to the receiver. An example of the LoS-NLoS-Indicator information element including the method field is presented in the following.

| -- ASN1START | |
|---|---|
| LOS-NLOS-Indicator-r17 ::= SEQUENCE { | |
| indicator-r17 | CHOICE { |
| soft-r17 | INTEGER (0..10), |
| hard-r17 | BOOLEAN, |
| ... | |
| }, | |
| method-r18 CHOICE { | |
| feature/model1 | BOOLEAN, |
| feature/model2 | BOOLEAN, |
| feature/model3 | BOOLEAN, |

```
    ...
    },
  ...
}
-- ASN1STOP
```

The indicator field (i.e., indicator-r17) provides information on the likelihood of a line-of-sight propagation path from the source to the receiver and it may include either a hard or soft value.

In case of a soft value, the indicator field specifies the likelihood of a LoS propagation path in the range between 0 and 1 with a 0.1-step resolution (scale factor 0.1; range 0 to 1). Value ‘0’ to ‘0.4’ may indicate NLoS, and value ‘0.6’ to ‘1’ may indicate LoS. Meanwhile, the value ‘0.5’ may mean that the estimated probability is equal, i.e., the adopted classifier cannot classify the current input. The value provides an estimate of the probability for a LoS propagation path between source and receiver.

In case of a hard value, the indicator field specifies whether the propagation path between the source and receiver is estimated to be LoS (true) or NLoS (false).

The method field provides information about which specific method(s)/technique(s) is utilized to determine the indicated LoS/NLoS value. The method/technique comprises a pre-determined or (pre-) configured model and/or feature set (e.g., deep neural network model #1 utilizing CIR RMS delay spread as a feature).

In block 409, the indication of the misclassification warning from the network (e.g., LMF) to the at least one user device for a (potential) misclassification may be carried, for example, within the LPP IE NR-DL-PRS-Expected-LoS-NLoS-Assistance by including a field called “nr-verify-ue-los-nlos-indicator” in the message. The NR-DL-PRS-Expected-LoS-NLoS-Assistance information element may used by the LMF to provide the expected likelihood of a LoS propagation path from a TRP to the at least one user device. An example of the NR-DL-PRS-Expected-LoS-NLoS-Assistance information element including the “nr-verify-ue-los-nlos-indicator” field is presented below.

-- ASN1START
NR-DL-PRS-Expected-LOS-NLOS-Assistance-r17 ::= SEQUENCE (SIZE
(1..nrMaxFreqLayers-r16)) OF

NR-DL-PRS-Expected-LOS-NLOS-

AssistancePerFreqLayer-r17
NR-DL-PRS-Expected-LOS-NLOS-AssistancePerFreqLayer-r17 :: =

SEQUENCE (SIZE

(1..nrMaxTRPsPerFreq-r16)) OF

NR-DL-PRS-Expected-LOS-NLOS-

AssistancePerTRP-r17
NR-DL-PRS-Expected-LOS-NLOS-AssistancePerTRP-r17 ::= SEQUENCE {

| dl-PRS-ID-r17 | INTEGER (0..255), | |
|---|---|---|
| nr-PhysCellID-r17 | NR-PhysCellID-r16 | OPTIONAL, -- Need |

ON

| | | |
|---|---|---|
| nr-CellGlobalID-r17 | NCGI-r15 | OPTIONAL, -- Need ON |
| nr-ARFCN-r17 | ARFCN-ValueNR-r15 | OPTIONAL, -- Need ON |

nr-los-nlos-indicator-r17 CHOICE {

| | |
|---|---|
| per-trp-r17 | LOS-NLOS-Indicator-r17, |
| per-resource-r17 | SEQUENCE (SIZE |

(1..nrMaxSetsPerTrpPerFreqLayer-r16)) OF

NR-DL-PRS-Expected-LOS-NLOS-

```
AssistancePerResource-r17,
      ...
      },
    nr-verify-ue-los-nlos-indicator-r18CHOICE {
```

| | |
|---|---|
| false-hard-r18 | BOOLEAN, |
| false-soft-r18 | INTEGER (0..10), |

```
      ...
      },
    ...
}
NR-DL-PRS-Expected-LOS-NLOS-AssistancePerResource-r17 ::=
```

SEQUENCE (SIZE (1..nrMaxResourcesPerSet-

r16)) OF

LOS-NLOS-Indicator-r17

-- ASN1STOP

The dl-PRS-ID field specifies the DL-PRS ID of the TRP for which the LoS/NLoS Information is provided.

The nr-PhysCellID field specifies the physical cell ID of the TRP for which the LoS/NLoS Information is provided.

The nr-CellGlobalID field specifies the NR cell global identifier (NCGI), i.e., the globally unique identity of a cell in NR, of the TRP for which the LoS/NLoS Information is provided.

The nr-ARFCN field specifies the NR absolute radio-frequency channel number (NR-ARFCN) of the TRP's cell-defining synchronization signal block (CD-SSB) corresponding to nr-PhysCellID.

The nr-los-nlos-indicator field provides the expected likelihood of a LoS propagation path from a TRP to the target user device (choice per-trp) or for all DL-PRS Resources of the TRP (choice per-resource).

The nr-verify-ue-los-nlos-indicator field provides the information whether the LoS/NLoS indicator provided by the target user device is false, either with one of the following choices: 1) false-hard: the provided LoS/NLoS indicator is false (parameter value set as true), or 2) false-soft: the provided LoS/NLoS indicator is false with probability between 0 and 1 for example with 0.1 steps resolution. Value ‘0’ may indicate that LoS/NLoS indicator is true, and value ‘1’ may indicate that LoS/NLoS indicator is false.

Alternatively, the warning indication may be provided first via the NRPPa Provide Assistance Data from LMF to gNB, and then from the gNB to the at least one user device via an RRC message.

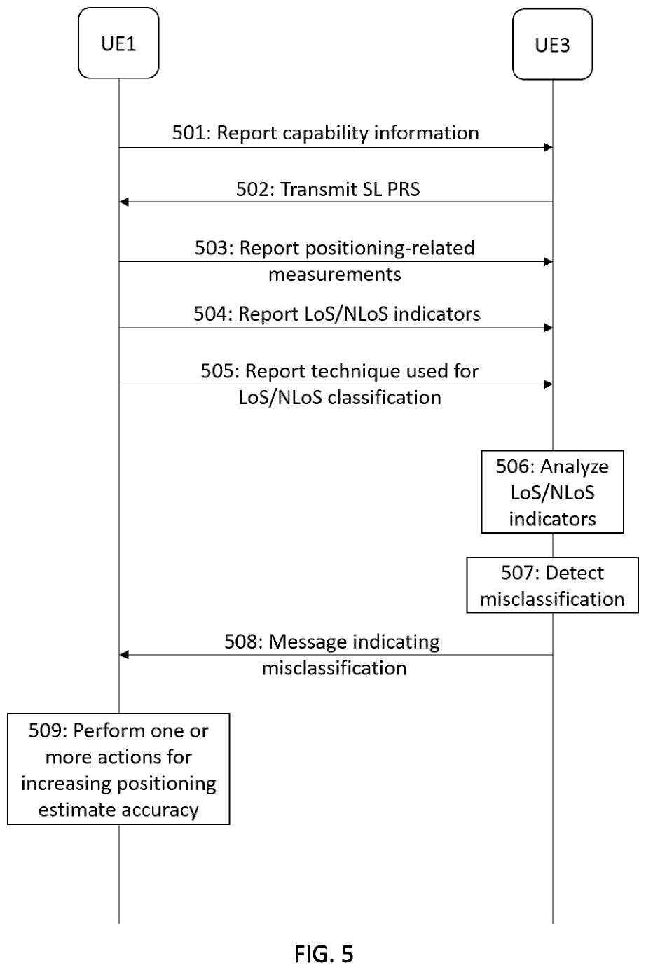

FIG. 5 illustrates a signaling diagram according to another example embodiment. In this example embodiment, user devices may transmit sidelink PRS to each other, and one of the UEs collects positioning-related measurements and LoS/NLoS indicators to detect a (potential) misclassification based on its analysis.

Referring to FIG. 5, in block 501, a plurality of user devices (UE1 in FIG. 5) may report capability information to a third user device (UE3 in FIG. 5) via sidelink. The plurality of user devices may comprise at least one first user device and at least one second user device. The plurality of user devices and the third user device may correspond to the UEs 100, 102 of FIG. 1.

For example, the capability information may indicate at least one of the following: a computational capability, one or more bandwidth capabilities, and/or one or more configured bandwidth parts of a given user device. The bandwidth capability may refer to an available or supported bandwidth at the user device for positioning. A given user device may be configured with one or more configured bandwidth parts (BWP) or carriers, each with its own channel bandwidth.

Herein it may be assumed that user devices with different positioning-related capabilities (e.g., supported BW, computational power, etc.) reside together in a certain area.

In block 502, the third user device transmits one or more sidelink positioning reference signals, which are measured by the plurality of user devices performing SL positioning. The plurality of user devices may also transmit one or more SL PRSs to the third user device and/or to each other.

In block 503, the plurality of user devices report positioning-related measurements to the third user device via sidelink. The positioning-related measurements may be associated with the SL PRS transmitted from the third user device and/or the SL PRS transmitted from the plurality of user devices. The positioning-related measurements may comprise, for example, at least one of the following: reference signal time difference (RSTD), time difference between reception of SL PRS and transmission of SL PRS, reference signal received power (RSRP), time of arrival (TOA), time of departure (TOD), angle of departure (AoD), angle of arrival (AoA), relative position, and/or range between the plurality of user devices.

In block 504, a given user device of the plurality of user devices reports at least one LoS/NLoS indicator to the third user device via sidelink based on the one or more sidelink positioning reference signals received from the third user device. Thus, the third user device obtains a plurality of LoS and NLoS indicators reported from the plurality of user devices. The plurality of LoS and NLoS indicators may comprise one or more LoS indicators and one or more NLoS indicators.

A given LoS/NLoS indicator may be a hard binary indicator, e.g., 0 or 1, or it may be a soft indicator between 0 and 1 representing a given user device's evaluation of the LoS probability. In other words, the LoS/NLoS indicator may be the LoS indicator or the NLoS indicator according to the probability. In this case, the LoS indicator may indicate a probability of LoS or a binary LoS classification, and the NLoS indicator may indicate a probability of NLoS or a binary NLoS classification.

In block 505, the plurality of user devices may report, to the third user device, via sidelink, the technique used by the user devices for LoS/NLoS classification. Some examples of the technique may include (but are not limited to) thresholding, clustering, use of probabilistic models, or use of machine learning techniques based on certain channel features, received signal characteristics, channel impulse response and/or estimated positioning-related parameters such as ToA and/or AoA . . . .

The reports of blocks 503-505 may be transmitted in separate messages, or they may be transmitted in a single message.

In block 506, the third user device analyzes the plurality of LoS and NLoS indicators reported from the plurality of user devices to check for any inconsistencies among the LoS/NLoS indicators. The third user device may further analyze the related measurements, capability information (BW, computational power, etc.), and/or spatial distribution of the user devices (e.g., based on rough/coarse location information).

Alternatively, or additionally, the third user device may analyze at least one of the following to check for any inconsistencies among the LoS/NLoS indicators: the user devices' relative position, range, or angle between them (over the sidelink), number of high-BW/complexity or low-BW/complexity user devices, and/or degree of probability of soft LoS/NLoS indicators (e.g., LoS with 0.9 probability vs LoS with 0.6 probability) reported by high-BW/complexity or low-BW/complexity user devices.

In block 507, the third user device detects, based on analyzing the plurality of LoS and NLoS indicators, a misclassification (or at least a possible/potential misclassification) associated with at least one LoS indicator or NLoS indicator of the plurality of LoS and NLoS indicators.

For example, the misclassification may be detected based at least partly on at least one of: the capability information of the plurality of user devices, the spatial distribution of the plurality of user devices, or the measurement information associated with the plurality of LoS and NLoS indicators.

Alternatively, or additionally, the misclassification may be detected based at least partly on at least one of: the relative position of the plurality of user devices, the range of the plurality of user devices, the angle between the plurality of user devices, or the angle between the plurality of user devices and a network node (e.g., gNB or TRP).

Alternatively, or additionally, the misclassification may be detected based at least partly on a number of first user devices and a number of second user devices among the plurality of user devices, wherein the second user devices are associated with a lower bandwidth or complexity than the first user devices. Herein the first user devices may refer to high-BW and/or high-complexity user devices, and the second user devices may refer to low-BW and/or low-complexity user devices (see the example scenarios of FIG. 9 and FIG. 10).

For example, if a low-BW user device reports a LoS indicator as opposed to a NLoS indicator reported by one or more high-BW user devices nearby (e.g., based on a rough location estimate available at the third user device), then the LoS indicator reported by the low-BW user device may be detected as misclassified.

As another example, if a low-BW user device reports a LoS indicator as opposed to a NLoS indicator reported by one or more high-BW user devices residing co-linearly with respect to a gNB or TRP (e.g., based on AoD information available at the third user device), then the LoS indicator reported by the low-BW user device may be detected as misclassified.

As another example, if a low-BW user device reports a LoS indicator as opposed to a NLoS indicator reported by one or more high-BW user devices nearby, and the one or more high-BW user devices report a relatively short range to the low-BW user device over sidelink, then the LoS indicator reported by the low-BW user device may be detected as misclassified.

As another example, if a user device using a certain feature (denoted as feature X) for channel classification reported a LoS indicator, and another user device nearby (e.g., based on rough location estimate available at the third user device) using another feature (denoted as feature Y) reported an NLoS indicator, and the third user device previously determined that feature Y provides better LoS/NLoS classification accuracy in the given environment compared to feature X, then the LoS indicator reported by the user device using feature X may be detected as misclassified.

In another example, if fewer high-BW user devices report a Los indicator with high confidence (probability), and more low-BW user devices report an NLoS indicator with low confidence, and the high-BW user devices are spatially located in a way that they would experience very similar channels with the low-BW user devices, then the NLoS indicator reported by the low-BW user devices may be detected as misclassified.

In another example, if fewer high-BW user devices report a Los indicator with low confidence (probability), and more low-BW user devices report an NLoS indicator with high confidence, and the high-BW user devices are spatially located in a way that they have different propagation conditions than the low-BW user devices, then the NLoS indicator reported by the low-BW user devices may not be detected as misclassified.

In block 508, in case of detecting a misclassification, the third user device generates and transmits a warning message indicating the misclassification associated with the at least one LoS or NLoS indicator of the plurality LoS and NLoS indicators. The third user device may transmit the warning message to the least one user device (e.g., low-BW and/or low-complexity UE), for which the misclassification was detected. Alternatively, the third user device may transmit the warning message to all user devices of the plurality of user devices.

The warning message may comprise an identifier of one or more user devices of the plurality of user devices, wherein the misclassification is based on a LoS or NLoS indicator reported from the one or more user devices. In other words, the warning message may comprise the IDs of the other user devices involved in the warning determination process. For example, the third user device may indicate, to a low-BW user device, that the high-BW user devices with IDs {Z} and {V} have reported a different LoS/NLoS indicator than the low-BW user device.

Alternatively, or additionally, the warning message may comprise information indicating a technique applied by one or more other user devices for determining a LoS or NLoS indicator reported from the one or more other user devices. This way, the third user device may help weaker user devices to find a better technique. The technique indicated by the third user device may correspond to the technique reported by the one or more other user devices in block 505.

Alternatively, or additionally, the warning message may comprise an indication for triggering sidelink measurements to exploit the reciprocity property of the channel to determine the LoS/NLoS condition. The triggering of sidelink measurements means that the at least one user device is triggered to transmit a sidelink positioning reference signal to the third user device, and the third user device measures the SL PRS transmitted by the at least one user device.

Alternatively, or additionally, the warning message may comprise an indication indicating a reliability of the misclassification. For example, the reliability may be indicated as a probability, e.g., a value between 0 and 1, or as a binary value indicating high or low probability.

In block 509, the at least one user device (for which the misclassification was detected) performs, based on the received warning message, one or more actions for increasing positioning estimate accuracy.

For example, the one or more actions may comprise transmitting, to one or more user devices, a request to confirm a LoS indicator or a NLoS indicator reported from the one or more user devices, wherein the misclassification is based on the LoS indicator or NLoS indicator reported from the one or more user devices. The at least one user device may identify the one or more user devices based on the identifier(s) that may be comprised in the warning message. In other words, the user device receiving the warning message may request (e.g., via sidelink) one or more nearby user devices (whose LoS/NLoS indicator report resulted in the inconsistency leading to the warning) to confirm their report. For example, the user device receiving the warning message may request another user device (e.g., high-BW or high-capability UE) in the area to verify the validity of the warning message based on the other user device's location estimation and/or historical data regarding LoS/NLoS information at the given location.

Alternatively, or additionally, the one or more actions may comprise transmitting, to one or more user devices, an indication indicating the misclassification, wherein the misclassification is based on a LoS indicator or a NLoS indicator reported from the one or more user devices. The at least one user device may identify the one or more user devices based on the identifier(s) that may be comprised in the warning message. In other words, the user device receiving the warning message may indicate (e.g., via sidelink) to one or more nearby user devices (whose LoS/NLoS indicator report resulted in the inconsistency) the outcome of such inconsistency.

Alternatively, or additionally, the one or more actions may comprise verifying a validity of the misclassification based on at least one of: a location estimation of the at least one user device, or historical information associated with one or more LoS or NLoS indicators at a location associated with the misclassification. In other words, the user device (for which the misclassification was detected) may verify the validity of the warning message based on its own location estimation and/or its own historical data regarding LoS/NLoS information at the given location.

Alternatively, or additionally, the one or more actions may comprise evaluating a classification accuracy associated with the at least one LoS or NLoS indicator reported by the at least one user device. In other words, the user device may re-investigate its LoS/NLoS classification accuracy.

Alternatively, or additionally, the one or more actions may comprise changing the classification outcome based on the warning, for example changing a Los indicator to an NLoS indicator, or changing an NLoS indicator to a LoS indicator. The changing may be based on the reliability of the misclassification, which may be indicated in the warning message.

Alternatively, or additionally, the one or more actions may comprise adjusting a classifier used to classify the at least one LoS or NLoS indicator reported by the at least one user device (for which the misclassification was detected). For example, the adjusting may mean using a different feature in the classifier. As another example, if a low-BW/complexity user device receives multiple warnings, it may change its classifier or request assistance from the third user device for such classifier change.

Alternatively, or additionally, the one or more actions may comprise disregarding a sidelink positioning reference signal associated with the misclassification. In other words, in this case, the at least one user device does not use or report the SL PRS associated with the misclassification for estimating its position. In this case, the at least one user device may do positioning estimation based on PRSs associated with LoS/NLoS indicators that did not result in a warning message.

Alternatively, or additionally, the one or more actions may comprise switching to a positioning technique that does not require the at least one LoS or NLoS indicator. In other words, the at least one user device may switch to another positioning scheme, for example fingerprinting-based positioning, which does not anticipate/require LoS/NLoS classification.

Alternatively, or additionally, the one or more actions may comprise disregarding (ignoring) the misclassification, if the at least one user device trusts its LoS/NLoS classification.

Alternatively, or additionally, in case the at least one user device received information indicating a technique applied by one or more other user devices for determining a LoS or NLoS indicator reported from the one or more other user devices, then the at least one user device may apply the indicated technique for its own LoS/NLoS classification. For example, this information may be received from the third user device in the warning message. Alternatively, the one or more other user devices may indicate to the least one user device (e.g., low-BW UE) directly via sidelink the technique they applied for LoS/NLoS classification.

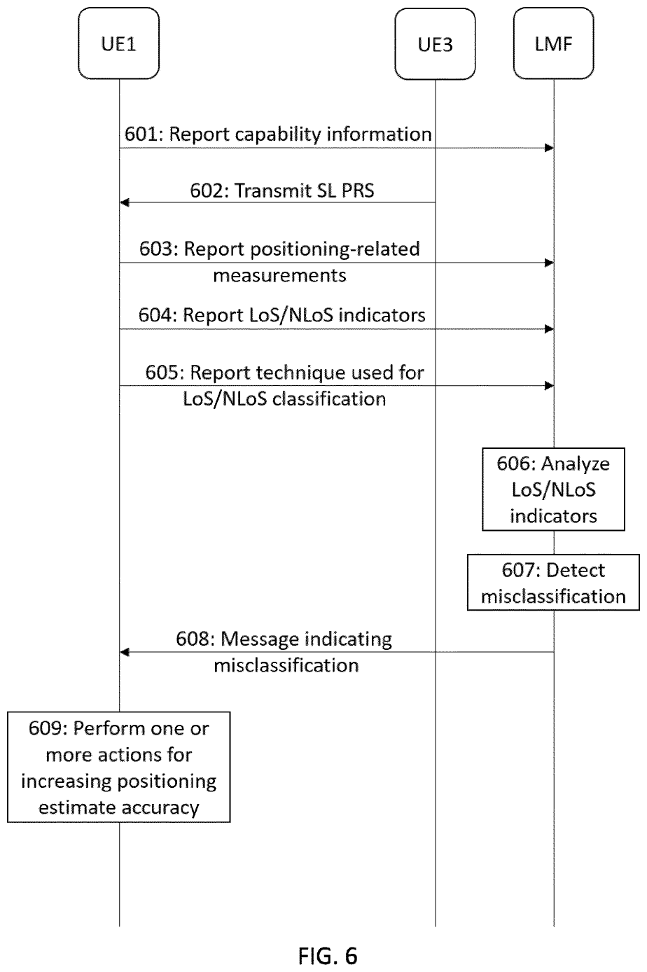

FIG. 6 illustrates a signaling diagram according to an example embodiment. In this example embodiment, the LMF may be the entity performing collecting the information and analyzing the LoS/NLoS indicators for detecting a (potential) misclassification, but for SL positioning (e.g., taking place in coverage).

Referring to FIG. 6, in block 601, a plurality of user devices report capability information to a network node and/or a core network entity (such as an LMF). For example, the user devices may report the capability information to the LMF via the LTE positioning protocol (LPP). Alternatively, the user devices may report the capability information to a network node (e.g., gNB or TRP) of a radio access network, and the network node may then forward the capability information to the LMF via NR positioning protocol A (NRPPa). The LMF may correspond to the LMF 112 of FIG. 1. The network node may correspond to the access node 104 or 106 of FIG. 1.

For example, the capability information may indicate at least one of the following: a computational capability, one or more bandwidth capabilities, and/or one or more configured bandwidth parts of a given user device. The bandwidth capability may refer to an available or supported bandwidth at the user device for positioning. A given user device may be configured with one or more configured bandwidth parts (BWP) or carriers, each with its own channel bandwidth.

Herein it may be assumed that user devices with different positioning-related capabilities (e.g., supported BW, computational power, etc.) reside together in a certain area.

In block 602, a third user device transmits one or more sidelink positioning reference signals, which are measured by the plurality of user devices performing SL positioning. The plurality of user devices may also transmit one or more SL PRSs to the third user device and/or to each other. The plurality of user devices may comprise at least one first user device and at least one second user device. The plurality of user devices and the third user device may correspond to the UEs 100, 102 of FIG. 1.

In block 603, the plurality of user devices report positioning-related measurements to the LMF. The positioning-related measurements may be associated with the DL PRS and/or the UL SRS. The positioning-related measurements may be associated with the SL PRS transmitted from the third user device and/or the SL PRS transmitted from the plurality of user devices. The positioning-related measurements may comprise, for example, at least one of the following: reference signal time difference (RSTD), time difference between reception of SL PRS and transmission of SL PRS, reference signal received power (RSRP), time of arrival (TOA), time of departure (TOD), angle of departure (AoD), angle of arrival (AoA), relative position, and/or range between the plurality of user devices.

For example, the user devices may report the measurements to the LMF via LPP. Alternatively, the user devices may report the measurements to the network node (e.g., gNB or TRP), and the network node may then forward the measurements to the LMF via NRPPa.

In block 604, a given user device of the plurality of user devices reports at least one LoS/NLoS indicator (for example, at least one LoS indicator and/or at least one NLoS indicator) to the LMF based on the one or more sidelink positioning reference signals received from the third user device. Thus, the LMF obtains a plurality of LoS and NLoS indicators reported from the plurality of user devices. The plurality of LoS and NLoS indicators may comprise one or more LoS indicators and one or more NLoS indicators.

For example, the user devices may report the LoS/NLoS indicators to the LMF via LPP. Alternatively, the user devices may report the LoS/NLoS indicators to the network node (e.g., gNB or TRP), and the network node may then forward the LoS/NLoS indicators to the LMF via NRPPa.

A given LoS/NLoS indicator may be a hard binary indicator, e.g., 0 or 1, or it may be a soft indicator between 0 and 1 representing a given user device's evaluation of the LoS probability. In other words, the LoS/NLoS indicator may be the LoS indicator or the NLoS indicator according to the probability. In this case, the LoS indicator may indicate a probability of LoS or a binary LoS classification, and the NLoS indicator may indicate a probability of NLoS or a binary NLoS classification.

In block 605, the plurality of user devices may report, to the LMF, the technique used by the user devices for LoS/NLoS classification. Some examples of the technique may include (but are not limited to) thresholding, clustering, use of probabilistic models, or use of machine learning techniques based on certain channel features, received signal characteristics, channel impulse response and/or estimated positioning-related parameters such as ToA and/or AoA.

For example, the user devices may report the technique to the LMF via LPP. Alternatively, the user devices may report the technique to the network node (e.g., gNB or TRP), and the network node may then forward the information to the LMF via NRPPa.

The reports of blocks 603-605 may be transmitted in separate messages, or they may be transmitted in a single message.

In block 606, the LMF analyzes the plurality of LoS and NLoS indicators reported from the plurality of user devices to check for any inconsistencies among the LoS/NLoS indicators. The LMF may further analyze the related measurements, capability information (BW, computational power, etc.), and/or spatial distribution of the user devices (e.g., based on rough/coarse location information).

Alternatively, or additionally, the third user device may analyze at least one of the following to check for any inconsistencies among the LoS/NLoS indicators: the user devices' relative position, range, or angle between them (over the sidelink), number of high-BW/complexity or low-BW/complexity user devices, and/or degree of probability of soft LoS/NLoS indicators (e.g., LoS with 0.9 probability vs LoS with 0.6 probability) reported by high-BW/complexity or low-BW/complexity user devices.

In block 607, the LMF detects, based on analyzing the plurality of LoS and NLoS indicators, a misclassification (or at least a possible/potential misclassification) associated with at least one LoS indicator or NLoS indicator of the plurality of LoS and NLoS indicators.

For example, the misclassification may be detected based at least partly on at least one of: the capability information of the plurality of user devices, the spatial distribution of the plurality of user devices, or the measurement information associated with the plurality of LoS and NLoS indicators.

Alternatively, or additionally, the misclassification may be detected based at least partly on at least one of: the relative position of the plurality of user devices, the range of the plurality of user devices, the angle between the plurality of user devices, or the angle between the plurality of user devices and the network node (e.g., gNB or TRP). The angle information may be part of the LMF's knowledge on the spatial distribution of the user devices, and it may comprise measurements between a given user device and the network node, and/or between a given user device and other user devices (in case of sidelink).

Alternatively, or additionally, the misclassification may be detected based at least partly on a number of first user devices and a number of second user devices among the plurality of user devices, wherein the second user devices are associated with a lower bandwidth or complexity than the first user devices. Herein the first user devices may refer to high-BW and/or high-complexity user devices, and the second user devices may refer to low-BW and/or low-complexity user devices (see the example scenarios of FIG. 9 and FIG. 10).

For example, if a low-BW user device reports a LoS indicator as opposed to a NLoS indicator reported by one or more high-BW user devices nearby (e.g., based on a rough location estimate available at the LMF), then the LoS indicator reported by the low-BW user device may be detected as misclassified.

As another example, if a low-BW user device reports a LoS indicator as opposed to a NLoS indicator reported by one or more high-BW user devices residing co-linearly with respect to a gNB or TRP (e.g., based on AoD information available at the LMF), then the LoS indicator reported by the low-BW user device may be detected as misclassified.

As another example, if a low-BW user device reports a LoS indicator as opposed to a NLoS indicator reported by one or more high-BW user devices nearby, and the one or more high-BW user devices report a relatively short range to the low-BW user device over sidelink, then the LoS indicator reported by the low-BW user device may be detected as misclassified.

As another example, if a user device using a certain feature (denoted as feature X) for channel classification reported a LoS indicator, and another user device nearby (e.g., based on rough location estimate available at the LMF) using another feature (denoted as feature Y) reported an NLoS indicator, and the LMF previously determined that feature Y provides better LoS/NLoS classification accuracy in the given environment compared to feature X, then the LoS indicator reported by the user device using feature X may be detected as misclassified.

In another example, if fewer high-BW user devices report a Los indicator with high confidence (probability), and more low-BW user devices report an NLoS indicator with low confidence, and the high-BW user devices are spatially located in a way that they would experience very similar channels with the low-BW user devices, then the NLoS indicator reported by the low-BW user devices may be detected as misclassified.

In another example, if fewer high-BW user devices report a Los indicator with low confidence (probability), and more low-BW user devices report an NLoS indicator with high confidence, and the high-BW user devices are spatially located in a way that they have different propagation conditions than the low-BW user devices, then the NLoS indicator reported by the low-BW user devices may not be detected as misclassified.

In block 608, in case of detecting a misclassification, the LMF generates and transmits a warning message indicating the misclassification associated with the at least one LoS or NLoS indicator of the plurality LoS and NLoS indicators.

The LMF may transmit the warning message to the least one user device (e.g., low-BW and/or low-complexity UE), for which the misclassification was detected. Alternatively, the LMF may transmit the warning message to all user devices of the plurality of user devices.

The warning message may comprise an identifier of one or more user devices of the plurality of user devices, wherein the misclassification is based on a LoS or NLoS indicator reported from the one or more user devices. In other words, the warning message may comprise the IDs of the other user devices involved in the warning determination process. For example, the LMF may indicate, to a low-BW user device, that the high-BW user devices with IDs {Z} and {V} have reported a different LoS/NLoS indicator than the low-BW user device.

Alternatively, or additionally, the warning message may comprise information indicating a technique applied by one or more other user devices for determining a LoS or NLoS indicator reported from the one or more other user devices. This way, the LMF may help weaker user devices to find a better technique. The technique indicated by the LMF may correspond to the technique reported by the one or more other user devices in block 605.

Alternatively, or additionally, the warning message may comprise an indication for triggering uplink measurements or sidelink measurements to exploit the reciprocity property of the channel to determine the LoS/NLoS condition.

Alternatively, or additionally, the warning message may comprise an indication indicating a reliability of the misclassification. For example, the reliability may be indicated as a probability, e.g., a value between 0 and 1, or as a binary value indicating high or low probability.

In block 609, the at least one user device (for which the misclassification was detected) performs, based on the received warning message, one or more actions for increasing positioning estimate accuracy.

For example, the one or more actions may comprise transmitting, to one or more user devices, a request to confirm a LoS indicator or a NLoS indicator reported from the one or more user devices, wherein the misclassification is based on the LoS indicator or NLoS indicator reported from the one or more user devices. The at least one user device may identify the one or more user devices based on the identifier(s) that may be comprised in the warning message. In other words, the user device receiving the warning message may request (e.g., via sidelink) one or more nearby user devices (whose LoS/NLoS indicator report resulted in the inconsistency leading to the warning) to confirm their report. For example, the user device receiving the warning message may request another user device (e.g., high-BW or high-capability UE) in the area to verify the validity of the warning message based on the other user device's location estimation and/or historical data regarding LoS/NLoS information at the given location.

Alternatively, or additionally, the one or more actions may comprise transmitting, to one or more user devices, an indication indicating the misclassification, wherein the misclassification is based on a LoS indicator or a NLoS indicator reported from the one or more user devices. The at least one user device may identify the one or more user devices based on the identifier(s) that may be comprised in the warning message. In other words, the user device receiving the warning message may indicate (e.g., via sidelink) to one or more nearby user devices (whose LoS/NLoS indicator report resulted in the inconsistency) the outcome of such inconsistency.

Alternatively, or additionally, the one or more actions may comprise verifying a validity of the misclassification based on at least one of: a location estimation of the at least one user device, or historical information associated with one or more LoS or NLoS indicators at a location associated with the misclassification. In other words, the user device (for which the misclassification was detected) may verify the validity of the warning message based on its own location estimation and/or its own historical data regarding LoS/NLoS information at the given location.

Alternatively, or additionally, the one or more actions may comprise evaluating a classification accuracy associated with the at least one LoS or NLoS indicator reported by the at least one user device. In other words, the user device may re-investigate its LoS/NLoS classification accuracy.

Alternatively, or additionally, the one or more actions may comprise changing the classification outcome based on the warning, for example changing a Los indicator to an NLoS indicator, or changing an NLoS indicator to a LoS indicator. The changing may be based on the reliability of the misclassification, which may be indicated in the warning message.

Alternatively, or additionally, the one or more actions may comprise adjusting a classifier used to classify the at least one LoS or NLoS indicator reported by the at least one user device (for which the misclassification was detected). For example, the adjusting may mean using a different feature in the classifier. As another example, if a low-BW/complexity user device receives multiple warnings, it may change its classifier or request assistance from the LMF for such classifier change.

Alternatively, or additionally, the one or more actions may comprise disregarding a positioning reference signal associated with the misclassification. In other words, in this case, the at least one user device does not use or report the SL PRS associated with the misclassification for estimating its position. In this case, the at least one user device may do positioning estimation based on SL PRSs associated with LoS/NLoS indicators that did not result in a warning message.

Alternatively, or additionally, the one or more actions may comprise switching to a positioning technique that does not require the at least one LoS or NLoS indicator. In other words, the at least one user device may switch to another positioning scheme, for example fingerprinting-based positioning, which does not anticipate/require LoS/NLoS classification.

Alternatively, or additionally, the one or more actions may comprise disregarding (ignoring) the misclassification, if the at least one user device trusts its LoS/NLoS classification.

Alternatively, or additionally, in case the at least one user device received information indicating a technique applied by one or more other user devices for determining a LoS or NLoS indicator reported from the one or more other user devices, then the at least one user device may apply the indicated technique for its own LoS/NLoS classification. For example, this information may be received from the LMF in the warning message. Alternatively, the one or more other user devices may indicate to the least one user device (e.g., low-BW UE) directly via sidelink the technique they applied for LoS/NLoS classification.

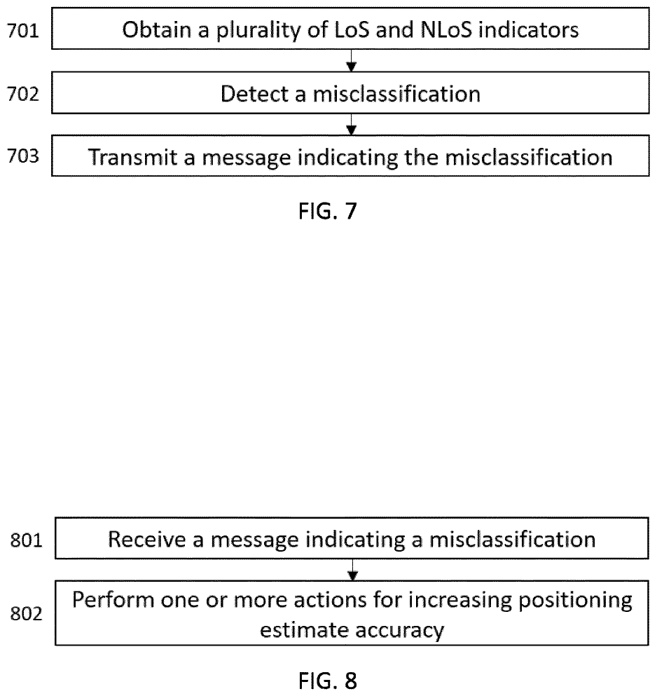

FIG. 7 illustrates a flow chart according to an example embodiment of a method performed by an apparatus. For example, the apparatus may be, or comprise, or be comprised in, a network node of a radio access network, or a core network entity such as a location management function (LMF) or location server. The network node may correspond to the access node 104 of FIG. 1, and the core network entity may correspond to the LMF 112 of FIG. 1, or the LMF of FIG. 4, or the LMF of FIG. 6.

As another example, the apparatus may be, or comprise, or be comprised in, a user device. The user device may also be called a subscriber unit, mobile station, remote terminal, access terminal, user terminal, terminal device, user equipment (UE), target UE, or target user device. The user device may correspond to one of the user devices 100, 102 of FIG. 1, or the UE3 of FIG. 5.

Referring to FIG. 7, in block 701, a plurality of line-of-sight, LoS, and non-line-of-sight, NLoS, indicators reported from a plurality of user devices are obtained.

In block 702, a misclassification associated with at least one LoS indicator or NLoS indicator of the plurality of LoS and NLoS indicators is detected.

In block 703, a message indicating the misclassification is transmitted.

FIG. 8 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, user equipment (UE), target UE, or target user device. The user device may correspond to one of the user devices 100, 102 of FIG. 1, or the UE of FIG. 4, or the UE1 of FIG. 5, or the UE1 of FIG. 6.

Referring to FIG. 8, in block 801, a message indicating a misclassification associated with at least one line-of-sight (LoS) indicator or non-line-of-sight (NLoS) indicator reported by the apparatus is received.

In block 802, one or more actions are performed, based on the message, for increasing positioning estimate accuracy.

The blocks, related functions, and information exchanges (messages) described above by means of FIGS. 4-8 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 9 illustrates an example scenario. In this scenario, high-BW and/or high-complexity UEs 911, 912, 913, 914 surround low-complexity and/or low-BW UEs 921, 922, 923, and the high-BW and/or high-complexity UEs 911, 912, 913, 914 report an opposite LoS/NLoS indicator compared to the low-BW and/or low-complexity UEs 921, 922, 923. In this case, the network detects that the report from the low-BW and/or low-complexity UEs 921, 922, 923 is possibly incorrect (i.e., misclassified).

FIG. 10 illustrates an example scenario. In this scenario, high-BW and/or high-complexity UEs 1011, 1012 reside co-linearly, i.e., on the same angle or AoD with a low-complexity and/or low-BW UE 1021 with respect to a TRP/gNB 1000, and the high-BW and/or high-complexity UEs 1011, 1012 report an opposite LoS/NLoS indicator compared to the low-BW and/or low-complexity UE 1021. In this case, the network detects that the LoS/NLoS indicator from the low-BW and/or low-complexity UE 1021 is possibly incorrect (i.e., misclassified).

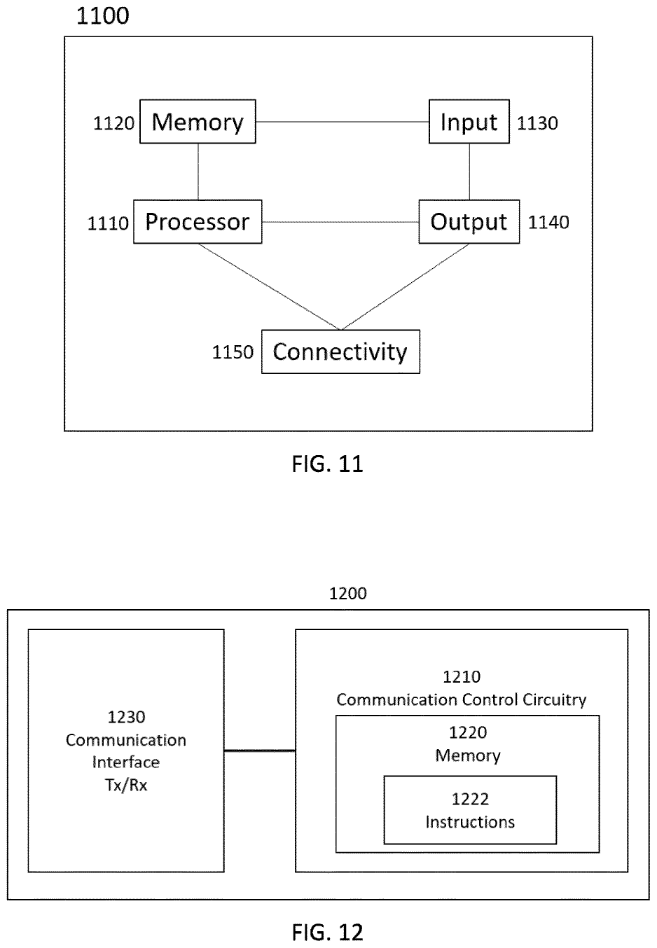

FIG. 11 illustrates an example of an apparatus 1100 comprising means for performing one or more of the example embodiments described above. For example, the apparatus 1100 may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, user equipment (UE), target UE, or target user device.

The apparatus 1100 may comprise a circuitry or a chipset applicable for realizing one or more of the example embodiments described above. For example, the apparatus 1100 may comprise at least one processor 1110. The at least one processor 1110 interprets instructions (e.g., computer program instructions) and processes data. The at least one processor 1110 may comprise one or more programmable processors. The at least one processor 1110 may comprise programmable hardware with embedded firmware and may, alternatively or additionally, comprise one or more application-specific integrated circuits (ASICs).

The at least one processor 1110 is coupled to at least one memory 1120. The at least one processor is configured to read and write data to and from the at least one memory 1120. The at least one memory 1120 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1120 stores computer readable instructions that are executed by the at least one processor 1110 to perform one or more of the example embodiments described above. For example, non-volatile memory stores the computer readable instructions, and the at least one processor 1110 executes the instructions using volatile memory for temporary storage of data and/or instructions. The computer readable instructions may refer to computer program code.

The computer readable instructions may have been pre-stored to the at least one memory 1120 or, alternatively or additionally, they may be received, by the apparatus, via an electromagnetic carrier signal and/or may be copied from a physical entity such as a computer program product. Execution of the computer readable instructions by the at least one processor 1110 causes the apparatus 1100 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1100 may further comprise, or be connected to, an input unit 1130. The input unit 1130 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1130 may comprise an interface to which external devices may connect to.

The apparatus 1100 may also comprise an output unit 1140. The output unit may comprise or be connected to one or more displays capable of rendering visual content, such as a light emitting diode (LED) display, a liquid crystal display (LCD) and/or a liquid crystal on silicon (LCoS) display. The output unit 1140 may further comprise one or more audio outputs. The one or more audio outputs may be for example loudspeakers.

The apparatus 1100 further comprises a connectivity unit 1150. The connectivity unit 1150 enables wireless connectivity to one or more external devices. The connectivity unit 1150 comprises at least one transmitter and at least one receiver that may be integrated to the apparatus 1100 or that the apparatus 1100 may be connected to. The at least one transmitter comprises at least one transmission antenna, and the at least one receiver comprises at least one receiving antenna. The connectivity unit 1150 may comprise an integrated circuit or a set of integrated circuits that provide the wireless communication capability for the apparatus 1100. Alternatively, the wireless connectivity may be a hardwired application-specific integrated circuit (ASIC). The connectivity unit 1150 may also provide means for performing at least some of the blocks of one or more example embodiments described above. The connectivity unit 1150 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1100 may further comprise various components not illustrated in FIG. 11. The various components may be hardware components and/or software components.

FIG. 12 illustrates an example of an apparatus 1200 comprising means for performing one or more of the example embodiments described above. For example, the apparatus 1200 may be, or comprise, or be comprised in, a network node of a radio access network, or a core network entity such as a location management function (LMF) or location server. The network node may correspond to the access node 104 of FIG. 1, and the core network entity may correspond to the LMF 112 of FIG. 1.

The apparatus 1200 may comprise, for example, a circuitry or a chipset applicable for realizing one or more of the example embodiments described above. The apparatus 1200 may be an electronic device comprising one or more electronic circuitries. The apparatus 1200 may comprise a communication control circuitry 1210 such as at least one processor, and at least one memory 1220 storing instructions 1222 which, when executed by the at least one processor, cause the apparatus 1200 to carry out one or more of the example embodiments described above. Such instructions 1222 may, for example, include a computer program code (software), wherein the at least one memory and the computer program code (software) are configured, with the at least one processor, to cause the apparatus 1200 to carry out one or more of the example embodiments described above. The at least one processor and the at least one memory storing the instructions may provide the means for providing or causing the performance of any of the methods and/or blocks described above.

The processor is coupled to the memory 1220. The processor is configured to read and write data to and from the memory 1220. The memory 1220 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1220 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1220 or, alternatively or additionally, they may be received, by the apparatus, via an electromagnetic carrier signal and/or may be copied from a physical entity such as a computer program product. Execution of the computer readable instructions causes the apparatus 1200 to perform one or more of the functionalities described above.

The memory 1220 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1200 may further comprise a communication interface 1230 comprising hardware and/or software for realizing communication connectivity according to one or more communication protocols. The communication interface 1230 comprises at least one transmitter (Tx) and at least one receiver (Rx) that may be integrated to the apparatus 1200 or that the apparatus 1200 may be connected to. The communication interface 1230 may provide means for performing some of the blocks for one or more example embodiments described above. The communication interface 1230 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1230 provides the apparatus with radio communication capabilities to communicate in the cellular communication system. The communication interface may, for example, provide a radio interface to one or more user devices. The apparatus 1200 may further comprise another interface towards a core network such as the network coordinator apparatus or AMF, and/or to the access nodes of the cellular communication system.

It is to be noted that the apparatus 1200 may further comprise various components not illustrated in FIG. 12. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1-25. (canceled)

26. An apparatus comprising at least one processor, and at least one memory storing instructions which, when executed by the at least one processor, cause the apparatus at least to perform:
obtaining a plurality of line-of-sight, LoS, and non-line-of-sight, NLoS, indicators reported from a plurality of user devices;
detecting a misclassification associated with at least one LoS indicator or NLoS indicator of the plurality of LoS and NLoS indicators; and
transmitting a message indicating the misclassification.

27. The apparatus according to claim 26, wherein the misclassification is detected based at least partly on at least one of:
capability information of the plurality of user devices, a spatial distribution of the plurality of user devices, or measurement information associated with the plurality of LoS and NLoS indicators;
a relative position of the plurality of user devices, a range of the plurality of user devices, an angle between the plurality of user devices, or an angle between the plurality of user devices and a network node;
a number of first user devices and a number of second user devices among the plurality of user devices, wherein the second user devices are associated with a lower bandwidth or complexity than the first user devices.

28. The apparatus according to claim 26, wherein the message comprises an identifier of one or more user devices of the plurality of user devices, wherein the misclassification is based on a LoS indicator or a NLoS indicator reported from the one or more user devices.

29. The apparatus according to claim 26, wherein at least a part of the plurality of LoS and NLoS indicators are related to a sidelink channel.

30. The apparatus according to claim 26, wherein a LoS indicator of the plurality of LoS and NLoS indicators indicates a probability of LoS or a binary LoS classification, and a NLoS indicator of the plurality of LoS and NLoS indicators indicates a probability of NLoS or a binary NLoS classification.

31. The apparatus according to claim 26, wherein the message comprises an indication for triggering uplink measurements or sidelink measurements.

32. An apparatus comprising at least one processor, and at least one memory storing instructions which, when executed by the at least one processor, cause the apparatus at least to perform:
receiving a message indicating a misclassification associated with at least one line-of-sight, LoS, indicator or non-line-of-sight, NLoS, indicator reported by the apparatus; and
performing, based on the message, one or more actions for increasing positioning estimate accuracy.

33. The apparatus according to claim 32, wherein the one or more actions comprise:
transmitting, to one or more user devices, a request to confirm a LoS indicator or a NLoS indicator reported from the one or more user devices, wherein the misclassification is based on the LoS indicator or the NLoS indicator reported from the one or more user devices;
transmitting, to one or more user devices, an indication indicating the misclassification, wherein the misclassification is based on a LoS indicator or a NLoS indicator reported from the one or more user devices;
verifying a validity of the misclassification based on at least one of: a location estimation of the apparatus, or historical information associated with one or more LoS or NLoS indicators at a location associated with the misclassification;
evaluating a classification accuracy associated with the at least one LoS indicator or NLoS indicator reported by the apparatus;
changing a LoS indicator to an NLoS indicator, or changing a NLoS indicator to a LoS indicator;
adjusting a classifier used to classify the at least one LoS indicator or NLoS indicator reported by the apparatus;
disregarding a positioning reference signal associated with the misclassification;
switching to a positioning technique that does not require the at least one LoS indicator or NLoS indicator; or
disregarding the misclassification.

34. The apparatus according to claim 33, wherein the message comprises an identifier of the one or more user devices.

35. The apparatus according to claim 32, wherein the message comprises an indication indicating a reliability of the misclassification,
wherein the changing is based on the reliability of the misclassification.

36. The apparatus according to claim 32, further being caused to:
receive information indicating a technique applied by one or more user devices for determining a LoS indicator or a NLoS indicator reported from the one or more user devices; and
apply the indicated technique.

37. A method comprising:
receiving, by an apparatus, a message indicating a misclassification associated with at least one line-of-sight, LoS, indicator or non-line-of-sight, NLoS, indicator reported by the apparatus; and
performing, by the apparatus, based on the message, one or more actions for increasing positioning estimate accuracy.

38. The method according to claim 37, wherein the one or more actions comprise:
transmitting, to one or more user devices, a request to confirm a LoS indicator or a NLoS indicator reported from the one or more user devices, wherein the misclassification is based on the LoS indicator or the NLoS indicator reported from the one or more user devices;
transmitting, to one or more user devices, an indication indicating the misclassification, wherein the misclassification is based on a LoS indicator or a NLoS indicator reported from the one or more user devices;
verifying a validity of the misclassification based on at least one of: a location estimation of the apparatus, or historical information associated with one or more LoS or NLoS indicators at a location associated with the misclassification;
evaluating a classification accuracy associated with the at least one LoS indicator or NLoS indicator reported by the apparatus;
changing a LoS indicator to an NLoS indicator, or changing a NLoS indicator to a LoS indicator;
adjusting a classifier used to classify the at least one LoS indicator or NLoS indicator reported by the apparatus;
disregarding a positioning reference signal associated with the misclassification;
switching to a positioning technique that does not require the at least one LoS indicator or NLoS indicator; or
disregarding the misclassification.

39. The method according to claim 38, wherein the message comprises an identifier of the one or more user devices.

40. The method according to claim 37, wherein the message comprises an indication indicating a reliability of the misclassification,
wherein the changing is based on the reliability of the misclassification.

41. The method according to claim 37, further comprising:
receiving information indicating a technique applied by one or more user devices for determining a LoS indicator or a NLoS indicator reported from the one or more user devices; and
applying the indicated technique.
